(19) United States
(12) Patent Application Publication
(10) Pub. No.: US 2005/0135643 A1
(43) Pub. Date: Jun. 23, 2005

(54) Apparatus and method of reproducing virtual sound

(76) Inventors: Joon-hyun Lee, Seongnam-si (KR); Seong-cheol Jang, Seongnam-si (KR)

Correspondence Address: STANZIONE & KIM, LLP, 1740 N STREET, N.W., FIRST FLOOR, WASHINGTON, DC, 20036, US

(21) Appl. No.: 10/982,842

(22) Filed: Nov. 8, 2004

(30) Foreign Application Priority Data
Dec. 17, 2003 (KR) 2003-92510

(51) Int. Cl. H04R 5/00; H04R 5/02

(52) U.S. Cl. 381/309; 381/310; 381/17

(57) ABSTRACT

An apparatus and method of reproducing a 2-channel virtual sound while dynamically controlling a sweet spot and crosstalk cancellation are disclosed. The method includes: receiving broadband signals, setting compensation filter coefficients according to response characteristics of bands and setting stereophonic transfer functions according to spectrum analysis; down mixing an input multi-channel signal into two channel signals by adding head related transfer functions (HRTFs) measured in a near-field and a far-field to the input multi-channel signal, canceling crosstalk of the down mixed signals on the basis of compensation filter coefficients calculated using the set stereophonic transfer functions, and compensating levels and phases of the crosstalk cancelled signals on the basis of the set compensation filter coefficients for each of the bands.

### CROSS-REFERENCE TO RELATED APPLICATIONS

This application claims the priority of Korean Patent Application No. 2003-92510, filed on Dec. 17, 2003, in the Korean Intellectual Property Office, the disclosure of which is incorporated herein in its entirety by reference.

### BACKGROUND OF THE INVENTION

1. Field of the Invention

The present general inventive concept relates to an audio reproduction system, and more particularly, to an apparatus and method of reproducing a 2-channel virtual sound capable of dynamically controlling a sweet spot and crosstalk cancellation.

2. Description of the Related Art

Commonly, a virtual sound reproduction system provides a surround sound effect similar to a 5.1 channel system, but using only two speakers.

Technology related to the virtual sound reproduction system is disclosed in WO 99/49574 (PCT/AU99/00002 filed 6 Jan. 1999 entitled AUDIO SIGNAL PROCESSING METHOD AND APPARATUS) and WO 97/30566 (PCT/GB97/00415 filed 14 Feb. 1997 entitled SOUND RECORD AND REPRODUCTION SYSTEM).

In a conventional virtual sound reproduction system, a multi-channel audio signal is down mixed to a 2-channel audio signal using a far-field head related transfer function (HRTF). The 2-channel audio signal is digitally filtered using left and right ear transfer functions H1(z) and H2(z) to which a crosstalk cancellation algorithm is applied. The filtered audio signal is converted into an analog audio signal by a digital-to-analog converter (DAC). The analog audio signal is amplified by an amplifier and output to left and right channels, i.e., 2-channel speakers. Since the 2-channel audio signal has 3 dimensional (3D) audio data, a listener can feel a surround effect.

However, the conventional technology of reproducing 2-channel virtual sound using a far-field HRTF uses an HRTF measured at a location at least 1 m from the center of a head. Accordingly, the conventional virtual sound technology provides exact sound information to a location where a sound source is placed, however, it cannot identify sound information for locations displaced from the sound source. Also, since the conventional technology of reproducing 2-channel virtual sound is developed under the assumption that each speaker has a flat frequency response, when a deteriorated speaker not having a flat frequency response is used, or when the frequency response of a speaker is not flat due to room acoustics where the speaker is installed, virtual sound quality is dramatically reduced. Also, in the conventional technology of reproducing a 2-channel virtual sound, even if a listener moves aside just a little from a sweet spot zone located at the center of two speakers, the virtual sound quality is dramatically reduced. Also, in the conventional technology of reproducing 2-channel virtual sound, since a crosstalk cancellation algorithm is suited only for a predetermined speaker arrangement, crosstalk cancellation in other speaker arrangements is dramatically reduced.

### SUMMARY OF THE INVENTION

Accordingly, the present general inventive concept provides a virtual sound reproduction apparatus and method to dynamically control a sweet spot and crosstalk cancellation by combining spatial compensation technology to compensate for sound quality of a listening position and 2-channel virtual sound technology.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a virtual sound reproduction method of an audio system, the method comprising: receiving broadband signals, setting compensation filter coefficients according to response characteristics of bands, and setting stereophonic transfer functions according to a spectrum analysis; down mixing an input multi-channel signal into two channel signals by adding head related transfer functions (HRTFs) measured in a near-field and a far-field to the input multi-channel signal; canceling crosstalk of the down mixed signals on the basis of compensation filter coefficients calculated using the set stereophonic transfer functions; and compensating levels and phases of the crosstalk cancelled signals on the basis of the set compensation filter coefficients for each of the bands.

The foregoing and/or other aspects and advantages of the present general inventive concept, may also be achieved by providing a virtual sound reproduction apparatus comprising: a down mixing unit to down mix an input multi-channel signal into two channel audio signals by adding HRTFs to the input multi-channel signal; a crosstalk cancellation unit to crosstalk filter the two channel audio signals down mixed by the down mixing unit using transaural filter coefficients reflecting acoustic transfer functions; and a spatial compensator to receive broadband signals, to generate compensation filter coefficients according to response characteristics for each band, and to generate the acoustic transfer functions according to spectrum analysis, and to compensate for a spatial frequency quality of the two channel audio signals output from the crosstalk cancellation unit using the compensation filter coefficients.

The foregoing and/or other aspects of the present general inventive concept may also be achieved by providing an audio reproduction system comprising: a virtual sound reproduction apparatus to receive broadband signals, to set compensation filter coefficients according to response characteristics for each band and to set stereophonic transfer functions according to a spectrum analysis, to down mix an input multi-channel signal into two channel signals by adding HRTFs measured in a near-field and a far-field to the input multi-channel signal, to cancel crosstalk between the down mixed signals based on compensation filter coefficients reflecting the set stereophonic transfer functions, and to compensate levels and phases of the crosstalk cancelled signals based on the set compensation filter coefficients according to the bands; and amplifiers to amplify audio signals compensated by a digital signal processor with a predetermined magnitude.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates an audio reproduction system according to an embodiment of the present general inventive concept;

FIG. 2 illustrates a down mixing unit of FIG. 1;

FIG. 3 illustrates a method of realizing a transaural filter of a crosstalk cancellation unit of FIG. 1;

FIG. 4 illustrates a spatial compensator of FIG. 1;

FIG. 5 illustrates a method of spatial compensation performed by the spatial compensation unit of FIG. 4;

FIG. 6 illustrates a method of reproducing virtual sounds in an audio reproduction system according to an embodiment of the present general inventive concept;

FIG. 7 illustrates a frequency quality in accordance with turning a room equalizer on/off; and

FIG. 8 illustrates different speaker arrangements.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

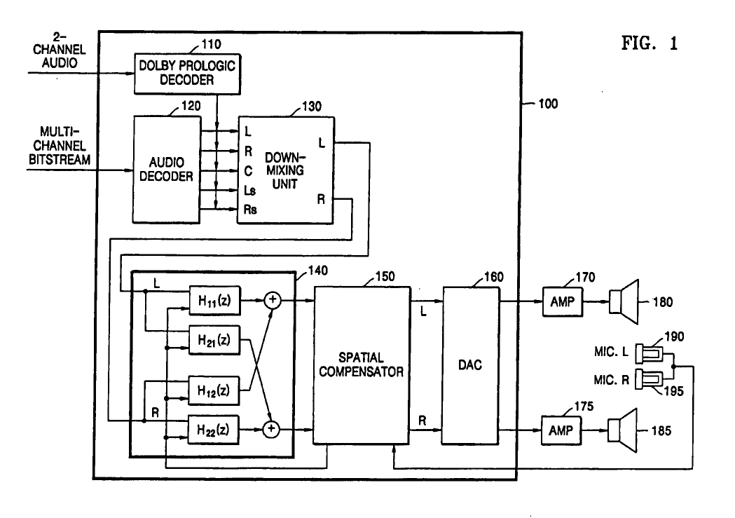

FIG. 1 is a block diagram illustrating an audio reproduction system according to an embodiment of the present general inventive concept.

Referring to FIG. 1, an audio reproduction system can include a virtual sound reproduction apparatus 100, left and right amplifiers 170 and 175, left and right speakers 180 and 185, and left and right microphones 190 and 195. The virtual sound reproduction apparatus 100 can include a dolby prologic decoder 110, an audio decoder 120, a down mixing unit 130, a crosstalk cancellation unit 140, a spatial compensator 150, and a digital-to-analog converter (DAC) 160.

The dolby prologic decoder 110 can decode an input 2-channel dolby prologic audio signal into 5.1 channel digital audio signals (a left-front channel, a right-front channel, a center-front channel, a left-surround channel, a right-surround channel, and a low frequency effect channel).

The audio decoder 120 can decode an input multi-channel audio bit stream into the 5.1 channel digital audio signals (the left-front channel, the right-front channel, the center-front channel, the left-surround channel, the right-surround channel, and the low frequency effect channel).

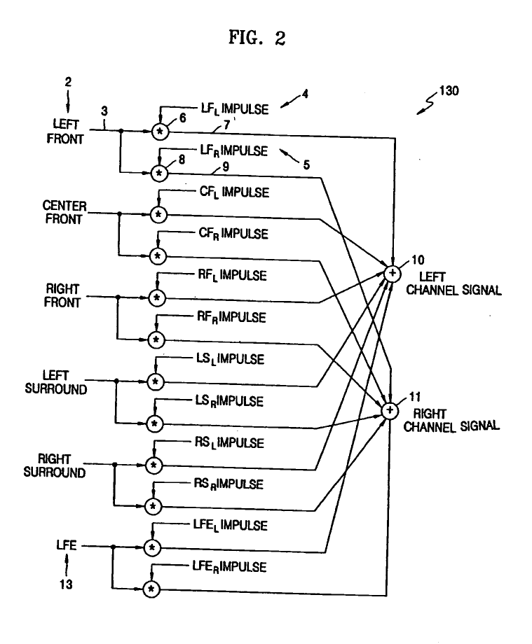

The down mixing unit 130 down mixes the 5.1 channel digital audio signals into two channel audio signals by adding direction information using an HRTF to the 5.1 channel digital audio signals output from the dolby prologic decoder 110 or the audio decoder 120. Here, the direction information is a combination of the HRTFs measured in a near-field and a far-field. Referring to FIG. 2, 5.1 channel audio signals are input to the down mixing unit 130. The 5.1 channels may be the left-front channel 2, the right-front channel, the center-front channel, the left-surround channel, the right-surround channel, and the low frequency effect channel 13. Left and right impulse response functions can be conducted on the 5.1 channels, respectively. Therefore, from the left-front channel 2, a left-front left (LF_{L}) impulse response function 4 may be convoluted in a step 6 with a left-front signal 3. The left-front impulse left (LF_{L}) response function 4 may be an impulse response to be output from a left-front channel speaker placed at an ideal position to be received by a left ear and is a mixture of the HRTFs measured in the near-field and the far-field. Here, the near-field and far-field HRTFs may be a transfer function measured at a location displaced less than 1 m from the center of a head and a transfer function measured at a location displaced more than 1 m from the center of the head, respectively. The step 6 may generate an output signal 7 to be added to a left channel signal 10 for a left channel. Similarly, a left-front right (LF_{R}) impulse response function 5 to be output from the left-front channel speaker placed at the ideal position to be received by a right ear may be convoluted in a step 8 with the left-front signal 3 to generate an output signal 9 added with a right channel signal 11 for a right channel. The remaining channels of the 5.1 channel audio signal may be similarly convoluted and output to the left and right channel signals 10 and 11. Therefore, 12 convolution steps may be required for the 5.1 channel signals in the down mixing unit 130. Accordingly, even if the 5.1 channel signals are reproduced as 2 channel signals by merging and down mixing the 5.1 channel signals and the HRTFs measured in the near-field and the far-field, a surround effect similar to when the 5.1 channel signals are reproduced as multi-channel signals can be generated.

The crosstalk cancellation unit 140 may digitally filter the down mixed 2 channel audio signals by applying a crosstalk cancellation algorithm using transaural filter coefficients H₁₁(Z), H₂₁(Z), H₁₂(Z), and H₂₂(Z). In the crosstalk cancellation algorithm, the transaural filter coefficients H₁₁(Z), H₂₁(Z), H₁₂(Z), and H₂₂(Z) can be set for crosstalk cancellation using acoustic transfer coefficients C₁₁(Z), C₂₁(Z), C₁₂(Z), and C₂₂(Z) generated by using a spectrum analysis in the spatial compensator 150.

The spatial compensator 150 can receive broadband signals output from the left and right speakers 180 and 185 via the left and right microphones 190 and 195, generate transaural filter coefficients H₁₁(Z), H_{d1}(Z), H₁₂(Z), and H₂₂(Z) representing frequency characteristics by frequency bands and the acoustic transfer coefficients C₁₁(Z), C₂₁(Z), C₁₂(Z), and C₂₂(Z) using the spectrum analysis, and compensate for the frequency characteristics, such as a signal delay and a signal level between the respective left and right speakers 180 and 185 and a listener, of the 2 channel audio signals output from the crosstalk cancellation unit 140 using the compensation filter coefficients H₁₁(Z), H₂₁(Z), H₁₂(Z), H₂₂(Z). Here, an infinite impulse response (IIR) filter or a finite impulse response (FIR) filter can be used as the compensation filter.

The DAC 160 converts the spatial compensated left and right audio signals into analog audio signals.

The left and right amplifiers 170 and 175 amplify the analog audio signals converted by the DAC 160 and output these signals to the left and right speakers 180 and 185, respectively.

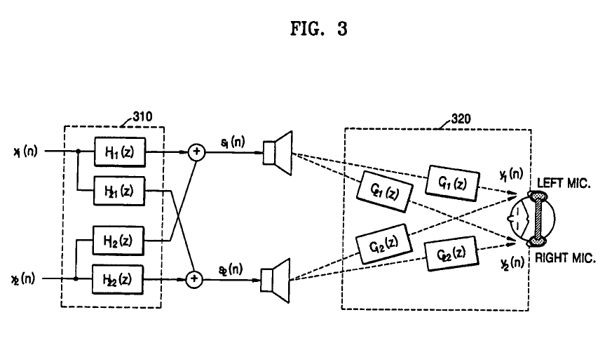

FIG. 3 illustrates a method of realizing a transaural filter 310 of the crosstalk cancellation unit of FIG. 1.

Referring to FIG. 3, sound values y₁(n) and y₂(n) may be respectively reproduced at a left ear and a right ear of a listener via two speakers. Sound values s₁(n) and s₂(n) may be input to the two speakers. The acoustic transfer coefficients C₁₁(Z), C₂₁(Z), C₁₂(Z), and C₂₂(Z) may be calculated through spectrum analysis performed on broadband signals.

When the listener listens to the sound values y₁(n) and y₂(n), the listener feels a virtual stereo sound. Since 4 acoustic spaces exist between the two speakers and the two ears, when the two speakers reproduce the sound values y₁(n) and y₂(n), respectively, sound values other than the original sound values y₁(n) and y₂(n) actually reach the two ears. Therefore, crosstalk cancellation should be performed so that the listener cannot hear a signal reproduced in a left speaker (or a right speaker) via the right ear (or the left ear).

A stereophonic reproduction system 320 can calculate the acoustic transfer functions C₁₁(Z), C₂₁(Z), C₁₂(Z), and C₂₂(Z) between the two speakers and the two ears of the listener using signals received via two microphones. In the transaural filter 310 transaural filter coefficients H₁₁(Z), H₂₁(Z), H₁₂(Z), and H₂₂(Z) are set on the basis of the acoustic transfer functions C₁₁(Z), C₂₁(Z), C₁₂(Z), and C₂₂(Z).

In a crosstalk cancellation algorithm, the sound values y₁(n) and y₂(n) can be given by an Equation 1 and the sound values s₁(n) and s₂(n) can be given by an Equation 2 below.
y₁(n)=C₁₁(Z)s₁(n)+C₁₂(Z)s₂(n)
y₂(n)=C₂₁(Z)s₁(n)+C₂₂(Z)s₂(n) [Equation 1]
s₁(n)=H₁₁(Z)x₁(n)+H₁₂(Z)x₂(n)
s₂(n)=H₂₁(Z)x₁(n)+H₂₂(Z)x₂(n) [Equation 2]

If a matrix H(Z), given by an Equation 4 below, of the transaural filter 310 is an inverse matrix of a matrix C(Z), given by Equation 3 below, of acoustic transfer functions between the two speakers and the two ears, the sound values y₁(n) and y₂(n) are input sound values x₁(n) and x₂(n), respectively. Therefore, if the input sound values x₁(n) and x₂(n) are substituted for the sound values y₁(n) and y₂(n), the sound values s₁(n) and s₂(n) input to the two speakers are as shown in Equation 2, and the listener hears the sound values y₁(n) and y₂(n).

$$\begin{matrix}[ \begin{matrix}{y}_{1} \\ {y}_{2}\end{matrix} ] = [ \begin{matrix}{C}_{11} & {C}_{12} \\ {C}_{21} & {C}_{22}\end{matrix} ] [ \begin{matrix}{s}_{1} \\ {s}_{2}\end{matrix} ] & [ Equation 3 ] \\ [ \begin{matrix}{s}_{1} \\ {s}_{2}\end{matrix} ] = {[ \begin{matrix}{C}_{11} & {C}_{12} \\ {C}_{21} & {C}_{22}\end{matrix} ]}^{- 1} [ \begin{matrix}{y}_{1} \\ {y}_{2}\end{matrix} ] & [ Equation 4 ]\end{matrix}$$

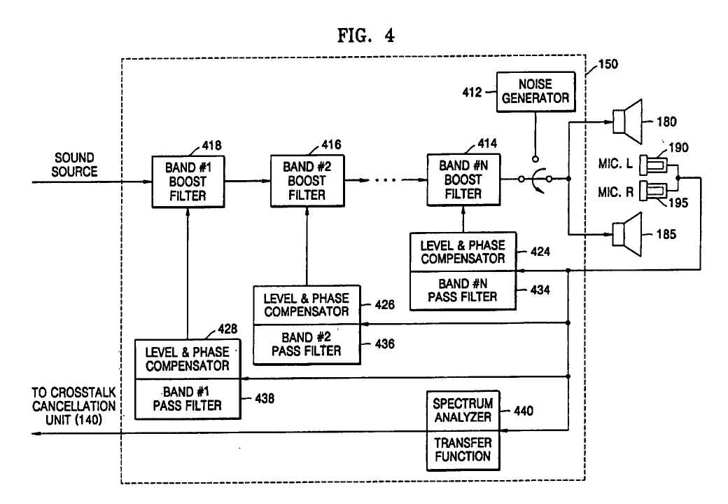

FIG. 4 is a block diagram illustrating the spatial compensator 150 of FIG. 1.

Referring to FIG. 4, a noise generator 412 can generate broadband signals and impulse signals. Band pass filters 434, 436, and 438 can perform band pass filtering on broadband signals output from the left and right speakers 180 and 185 and received via the left and right microphones 190 and 195 in N bands. Level and phase compensators 424, 426, and 428 can generate compensation filter coefficients to compensate levels and phases of the signals band pass filtered by the band pass filters 434, 436, and 438 in N bands. Boost filters 414, 416, . . . , and 418 may compensate for a frequency quality of input audio signals to attain a flat frequency response by applying band compensation filter coefficients generated by the level and phase compensators 424, 426, and 428 to the input audio signal. Also, a spectrum analyzer 440 may analyze spectra of the broadband signals output from the left and right speakers 180 and 185 and received via the left and right microphones 190 and 195 and may calculate the transfer functions C₁₁(Z), C₂₁(Z), C₁₂(Z), and C₂₂(Z) between the two speakers 180 and 185 and the two ears of a listener for a stereophonic reproduction system.

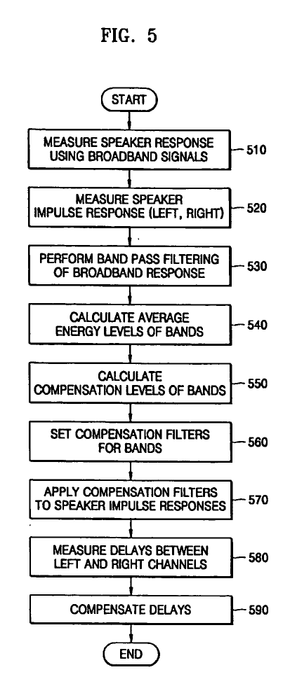

FIG. 5 is a flowchart illustrating a method of spatial compensation of the spatial compensator 150 of FIG. 4.

Speaker response characteristics can be measured using broadband signals and impulse signals in operation 510.

Left and right speaker impulse response characteristics can be measured in operation 520.

Band pass filtering of the broadband speaker response characteristics for each of N bands can be performed in operation 530.

An average energy levels of each band can be calculated in operation 540.

A compensation level of each band can be calculated using the calculated average energy levels in operation 550.

A boost filter coefficient for each band can be set using the calculated band compensation levels in operation 560.

Boost filters 414, 416 and 418 can be applied to the speaker impulse responses using the set band boost filter coefficients in operation 570.

Delays between left and right channels can be measured using the speaker impulse response characteristics in operation 580.

Phase compensation coefficients can be set using the delays between the left and right channels in operation 590. That is, delays caused by timing differences between the left and right speakers can be compensated for by controlling the delays between the left and right channels.

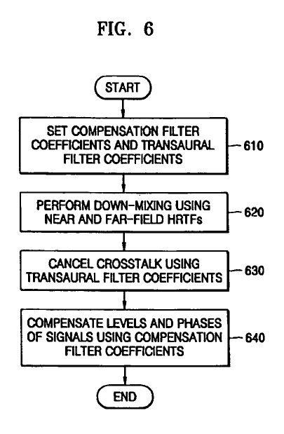

FIG. 6 is a flowchart illustrating a method of reproducing virtual sounds in an audio reproduction system.

In operation 610, broadband signals and impulse signals can be generated by left and right speakers, i.e., 180 and 185 of FIG. 4, the broadband signals and impulse signals can be received via left and right microphones, i.e., 190 and 195, sound pressure levels and signal delays between the left and right speakers 180 and 185 can be controlled, and digital filter coefficients for producing a flat frequency response can be set using the sound pressure levels and signal delays. Also, optimal transaural filter coefficients H₁₁(Z), H₂₁(Z), H₁₂(Z), and H₂₂(Z) for crosstalk cancellation can be set by calculating stereophonic transfer functions between the speakers, i.e., 180 and 185 and ears of a listener using signals received via the microphones, i.e., 190 and 195.

A multi-channel audio signal is down mixed into 2 channel audio signals using near and far-field HRTFs in operation 620.

The down mixed audio signals may be digitally filtered on the basis of the optimal transaural filter coefficients H₁₁(Z), H₂₁(Z), H₁₂(Z), and H₂₂(Z) for the crosstalk cancellation in operation 630.

The crosstalk canceled audio signals may be spatially compensated by reflecting level and phase compensation filter coefficients in operation 640.

Eventually, the 2 channel audio signals provide an optimal surround sound effect at a current position of the listener using the crosstalk cancellation and spatial compensation.

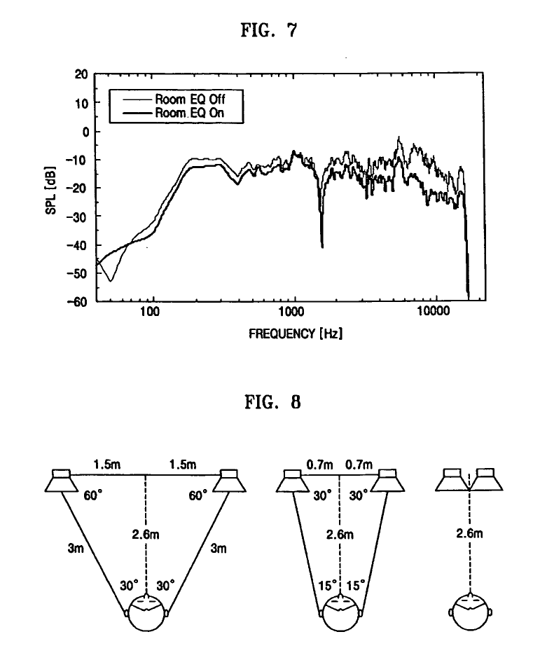

FIG. 7 is a graph illustrating frequency a quality of the left and right speakers 180 and 185 when the spatial compensator 150 of FIG. 4 operates. Referring to FIG. 7, when a room equalizer is turned on, the frequency response of the speakers is flat.

The present general inventive concept can also be embodied as computer readable codes on a computer readable recording medium. The computer readable recording medium may be any data storage device that can store data which can be thereafter read by a computer system. Examples of the computer readable recording medium may include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code can be stored and executed in a distributed fashion.

As described above, in conventional technology, while a surround effect provided by two 5.1 channel speakers is optimal in a sweet spot zone, a virtual surround effect is dramatically decreased anywhere besides the sweet spot zone. However, since a position of a sweet spot can be dynamically controlled, wherever a listener is located, an optimal 2 channel virtual sound surround effect can be provided to the listener. Also, through spatial compensation, a virtual sound effect may be made much better by having a flat frequency response as shown in FIG. 7. Also, as shown in FIG. 8, the virtual sound effect can be improved by dramatically compensating for changes in a speaker arrangement and a listener position through crosstalk cancellation using two microphones, i.e., 190 and 195.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A virtual sound reproduction method of an audio system, the method comprising:
receiving broadband signals, setting compensation filter coefficients according to response characteristics of bands, and setting stereophonic transfer functions according to a spectrum analysis;
down mixing an input multi-channel signal into two channel signals by adding head related transfer functions (HRTFs) measured in a near-field and a far-field to the input multi-channel signal;
canceling crosstalk of the down mixed signals on the basis of compensation filter coefficients calculated using the set stereophonic transfer functions; and
compensating levels and phases of the crosstalk cancelled signals on the basis of the set compensation filter coefficients for each of the bands.

2. The method of claim 1, wherein the setting of compensation filter coefficients comprises:
measuring speaker response characteristics on the basis of the broadband signals and impulse signals;
band pass filtering the measured broadband speaker response characteristics into N bands;
calculating average energy levels of the band pass filtered band frequencies;
calculating a compensation level for each of the bands using the calculated average energy levels;
setting a level compensation filter coefficient for each of the bands using the calculated band compensation levels.

3. The method of claim 1, wherein the setting compensation filter coefficients comprises:
measuring left and right speaker impulse response characteristics;
measuring delays between left and right channels;
setting phase compensation filter coefficients on the basis of the measured delays between the left and right channels.

4. The method of claim 1, wherein the setting stereophonic transfer functions comprises:
setting stereophonic transfer functions between speakers and ears of a listener based on signals received via two microphones.

5. The method of claim 1, wherein the compensation filter coefficients are FIR filter coefficients.

6. The method of claim 1, wherein the down mixing comprises:
mixing the HRTFs measured in the near-field and the far-field.

7. The method of claim 1, wherein a matrix of the compensation filter coefficients is an inverse matrix of a matrix of acoustic transfer functions between two speakers and two ears.

8. The method of claim 1, wherein the compensating levels and phases of the crosstalk cancelled signals comprises:
compensating the levels and phases of the signals based on the compensation filter coefficients for each band.

9. A virtual sound reproduction apparatus comprising:
a down mixing unit to down mix an input multi-channel signal into two channel audio signals by adding HRTFs to the input multi-channel signal;
a crosstalk cancellation unit to crosstalk filter the two channel audio signals down mixed by the down mixing unit using transaural filter coefficients reflecting acoustic transfer functions; and
a spatial compensator to receive broadband signals, to generate compensation filter coefficients according to response characteristics for each band and generate the acoustic transfer functions according to spectrum analysis, and to compensate spatial frequency quality of two channel audio signals output from the crosstalk cancellation unit using the compensation filter coefficients.

10. The apparatus of claim 9, wherein the crosstalk cancellation unit comprises:
a stereophonic coefficient generator to generate acoustic transfer functions between speakers and ears of a listener on the basis of signals received via two microphones; and
a filter unit to set compensation filter coefficients based on the acoustic transfer functions generated by the stereophonic coefficient generator and to filter the down mixed two channel audio signals.

11. The apparatus of claim 9, wherein the spatial compensator comprises:
band pass filters to band pass filter broadband signals output from left and right speakers and received via left and right microphones according to bands;
compensators to compensate for levels and phases of signals band pass filtered by the band pass filter according to bands; and
boost filters to compensate for a frequency quality of input audio signals to have a flat frequency response by applying band compensation filter coefficients generated by the compensator to the input audio signals.

12. The apparatus of claim 9, wherein the spatial compensator comprises:
a frequency spectrum unit to analyze spectra of the broadband signals output from the left and right speakers and received via the left and right microphones and to calculate the stereophonic transfer functions between the speakers and the ears of the listener.

13. The apparatus of claim 9, wherein the transaural filter of the crosstalk cancellation unit is one of an IIR filter and an FIR filter.

14. The apparatus of claim 9, wherein the compensation filter of the spatial compensator is one of the IIR filter and the FIR filter.

15. The apparatus of claim 9, further comprising:
a dolby prologic decoder to decode an input two channel signal into the input multi-channel signal;
an audio decoder to decode an input audio bit stream into the input multi-channel signal; and
a digital to analog converter to convert signals output from the spatial compensator to analog audio signals.

16. An audio reproduction system comprising:
a virtual sound reproduction apparatus to receive broadband signals, to set compensation filter coefficients according to response characteristics for each band to set stereophonic transfer functions according to a spectrum analysis, to down mix an input multi-channel signal into two channel signals by adding HRTFs measured in a near-field and a far-field to the input multi-channel signal, to cancel crosstalk between the down mixed signals based on compensation filter coefficients reflecting the set stereophonic transfer functions, and to compensate for levels and phases of the crosstalk cancelled signals based on the set compensation filter coefficients according to bands; and
amplifiers to amplify audio signals compensated by a digital signal processor with a predetermined magnitude.

17. The system of claim 16, wherein the input multi-channel signal is from a left-front channel, a right-front channel, a center front channel, a left-surround channel, a right surround channel, and a low frequency effect channel.

18. The system of claim 16, further comprising:
left and right speakers to output broadband signals; and
left and right microphones to receive the broadband signals output from the left and right speakers and output the broadband signals to the virtual sound reproduction apparatus.

19. A computer-readable recording medium containing code providing a virtual sound reproduction method used by an audio system, the method comprising the operations of:
receiving broadband signals, setting compensation filter coefficients according to response characteristics of bands, and setting stereophonic transfer functions according to spectrum analysis;
down mixing an input multi-channel signal into two channel signals by adding head related transfer functions (HRTFs) measured in a near-field and a far-field to the input multi-channel signal;
canceling crosstalk of the down mixed signals on the basis of compensation filter coefficients calculated using the set stereophonic transfer functions; and
compensating levels and phases of the crosstalk cancelled signals on the basis of the set compensation filter coefficients for each of the bands.

20. The computer-readable recording medium of claim 19, wherein the operation of setting the compensation filter coefficients comprises:
measuring speaker response characteristics on the basis of the broadband signals and impulse signals;
band pass filtering the measured broadband speaker response characteristics into N bands;
calculating average energy levels of the band pass filtered band frequencies;
calculating a compensation level for each of the bands using the calculated average energy levels;
setting a level compensation filter coefficient for each of the bands using the calculated band compensation levels.

21. The computer-readable recording medium of claim 19, wherein the operation of setting the compensation filter coefficients comprises:
measuring left and right speaker impulse response characteristics;
measuring delays between left and right channels;
setting phase compensation filter coefficients on the basis of the measured delays between the left and right channels.

22. The computer-readable recording medium of claim 19, wherein the operation of setting the stereophonic transfer functions comprises:
setting stereophonic transfer functions between speakers and ears of a listener based on signals received via two microphones.

23. The computer-readable recording medium of claim 19, wherein the compensation filter coefficients are FIR filter coefficients.

24. The computer-readable recording medium of claim 19, wherein the operation of down mixing comprises:
mixing the HRTFs measured in the near-field and the far-field.

25. The computer-readable recording medium of claim 19, wherein a matrix of the compensation filter coefficients is an inverse matrix of a matrix of acoustic transfer functions between two speakers and two ears.

26. The computer-readable recording medium of claim 19, wherein the operation of compensating the levels and phases of the crosstalk cancelled signals comprises:
compensating the levels and phases of the signals based on the compensation filter coefficients for each band.
